(19) United States
(12) Patent Application Publication
(10) Pub. No.: US 2016/0010718 A1
(43) Pub. Date: Jan. 14, 2016

(54) SELF-LOCKING CYLINDER FOR A DOOR OF A MOTOR VEHICLE

(71) Applicant: Richard HERAULT, Genas (FR)

(72) Inventor: Richard Herault, Genas (FR)

(73) Assignee: COMPAGNIE PLASTIC OMNIUM, Lyon (FR)

(21) Appl. No.: 14/773,004

(22) PCT Filed: Mar. 6, 2014
(86) PCT No.: PCT/EP2014/054363

§ 371 Date: Sep. 4, 2015

(30) Foreign Application Priority Data
Mar. 6, 2013 (EP) 13158060.7

(51) Int. Cl. F16F 9/58

(52) U.S. Cl. CPC F16F 9/585

(57) ABSTRACT

A cylinder for a movable bodywork element of a motor vehicle, capable of containing a fluid, comprising a chamber and a piston. The piston consists of a rod and a head. The head of the piston has a surface opposite the rod that faces a surface at the bottom of the chamber. The bottom of the cylinder chamber comprises at least one stop. The stop has a contact surface impermeable to fluid that faces at least a portion of at least one of the surfaces. The contact surface of the stop is arranged in such a way as to expel the fluid located between the contact surface and the portion of at least one of the surfaces.

This invention relates to the field of motor vehicle openings.

Motor vehicle tailgates comprising gas or hydraulic cylinders are already known.

These cylinders help the user to open the tailgate by taking up its weight.

Cylinders comprising a chamber and a piston consisting of a rod and a head are known in the state of the art, the head having a surface opposite the rod and a surface in contact with the rod, said surfaces each being opposite a surface of a bottom of the chamber. We may mention for example the patent application EP 0 802 331 and documents U.S. Pat. No. 4,242,946, U.S. Pat. No. 2,856,035 or JP HO 3 43139 U.

However, these systems do not solve the problems of counter-thrust of the piston when it is at end of stroke.

The inventor submitting this application discovered that, in tailgates made of thermoplastic material, in other words having at least one of the panels made of thermoplastic material, the thrust of the cylinders which is permanently exerted on the tailgate, including when closed, eventually causes unwanted deformations, especially when the tailgate is exposed for a long time under a powerful sun.

The invention aims to overcome these disadvantages.

The invention aims in particular to modulate the cylinder thrust force, especially in its end of stroke position.

The invention relates to a cylinder for a movable bodywork element of a motor vehicle capable of containing a fluid, comprising a chamber and a piston consisting of a rod and a head, the head having a surface opposite the rod and a surface in contact with the rod, said surfaces each being opposite a surface of a bottom of the chamber, characterised in that the cylinder comprises at least one stop opposite at least one of the surfaces, the stop having at least one contact surface impermeable to the fluid, the contact surface being opposite a portion of at least one of the surfaces and being arranged to press against the portion of at least one of the surfaces so as to expel the fluid located between the contact surface and said portion.

In a particular embodiment, a surface of a bottom of the chamber comprises a stop having a contact surface impermeable to the fluid arranged to press against a portion of a surface of the piston head, so as to expel the fluid located between said surface of the piston head and said contact surface of the stop.

In another embodiment, a surface of the head comprises a stop having a contact surface impermeable to the fluid arranged to press against a portion of a surface of a bottom of the chamber, so as to expel the fluid located between said surface of the bottom of the chamber and said contact surface of the stop.

In the cylinder according to the invention, a portion of the surface of the bottom of the chamber is neutralised by a surface impermeable to the fluid(s) when the piston reaches the end of stroke, which cancels, significantly reduces, or reverses the cylinder thrust.

In a first case where the stop is located on the side opposite the piston rod, when said stop is configured so that the piston thrust is reversed while the piston is depressed at end of stroke, the cylinder tends to remain depressed under the effect of this reverse thrust and traction must be exerted to take it off its depressed position. Once off, the piston is subjected again to the thrust tending to push it out of the cylinder. The result is a hard point on the piston trajectory, since a force must be overcome to start it moving again.

Conversely, in a second case where the stop is located on the side of the piston rod, the cylinder thrust is always increased when the piston is out at end of stroke so that the cylinder tends to remain out under the effect of the increased thrust to which it is subjected, even if a thrust less than this increased thrust is exerted on it. The result is therefore once again a hard point since an increased resistance of the cylinder at end of stroke must be overcome to start it moving again.

In the invention, “bottom of the chamber” means the portion of the cylinder chamber which comes into contact with

either the surface of the piston head opposite the rod when the piston is retracted at end of stroke position, or in a position where the piston is essentially depressed,

or the surface of the piston head in contact with the rod when the piston is out at end of stroke position, or in a position where the piston is essentially out.

In the invention, the terms “a portion of at least one of the surfaces” must be interpreted as meaning all or some of said surfaces. Therefore, the contact surface of the stop is opposite either a portion, or all, of the surface of at least one of the surfaces of the bottom of the chamber, the surface of the piston head opposite the rod or the surface of the piston head in contact with the rod.

Thanks to the invention, when the cylinder is in the position in which its piston head is in contact with the impermeable surface, the action of the cylinder on the door is reduced or even cancelled.

According to one embodiment, the fluid contained in the chamber of the cylinder according to the invention is a gas or a liquid, or a mixture thereof. The fluids suitable for the cylinder of the invention are gases such as air, CO₂, nitrogen, oxygen, or more or less viscous liquids, in particular water, oils, etc. In the invention, “mixture thereof” means mixtures of gases, mixtures of liquids or mixtures of gases and liquids, in suitable proportions easily determined by those skilled in the art. Air will be considered as a gas or a mixture of simple gases.

According to another advantageous embodiment, the contact surface of the stop is soft and deformable, and has a hardness less than or equal to 90 Shore A.

Due to its deformability, the contact surface of the stop is capable of removing, or significantly reducing the pressure exerted by the fluid. In one aspect of the invention, the deformability also offers a means of evacuating the fluid located between the contact surface of the stop and the surface of the piston head opposite the rod, for example by suction effect. Bringing the stop into contact with the surface of the piston head or the bottom of the chamber without creating a suction effect, is also advantageous.

Advantageously, the contact surface of the stop consists of a layer of material having elastic deformability properties, the material being in particular rubber, elastomer or polyamide. Convoluted foam materials, in particular composite, may also be advantageous.

In the invention, the contact surface of the stop is defined by the fact that it consists of a layer of material. This means that the stop can be coated with a material impermeable to the fluid, and may in particular have at least one of the aforementioned properties (deformable and soft), whether a coating of one or more layers, or whether the stop consists entirely of said material.

The stop material is impermeable to the fluid, which means that due to the nature of the material, the fluid contained in the cylinder chamber cannot penetrate or impregnate the material.

In the case of composite materials, with cavities due to foaming, inflation or polymerisation, the cavities of the material are not connected, so that only the outer cavities of the material, in other words the cavities exposed to the outside of the material, can contain the fluid of the chamber.

According to another embodiment compatible with the preceding embodiments, the size of the contact surface of the stop is equivalent to that of the surface of the piston head or the surface of the bottom of the chamber. In other words, the area of the contact surface is approximately equal to the area of the surface of the piston head opposite the rod. In the invention, “approximately equal” means that the areas are equal with a margin of error of plus or minus 10%, in particular ±5%. In other words, and by way of example, if the area of the surface of the piston head is 5 cm², the area of the contact surface may vary from 4.9 cm² to 5.1 cm², in particular the area of the contact surface may vary from 4.95 cm² to 5.05 cm².

According to an embodiment compatible with the preceding embodiments, the contact surface of the stop may contain means to expel the fluid trapped between said contact surface and the surface of the head opposite the rod when the piston reaches its end of stroke, in the form of channels, grooves, microfurrows, or any other means.

Advantageously, the stop is substantially identical in shape, or adapted to the shape of the piston chamber, the chamber being for example cylindrical of circular cross-section, rectangular or elliptical. The stop can be positioned in the centre of the surface of the bottom of the chamber or of the piston head. The stop may be solid or comprise at least one recess, in particular a recess in the centre of the stop, such as a ring, for example of circular cross-section, rectangular or elliptical.

According to another embodiment compatible with the preceding embodiments, the piston head slides with clearance in the cylinder chamber, allowing fluid to flow from one side of the piston head to thee other, this flow being reduced due to the narrowness of the clearance so as to act as a damper.

The invention further relates to a movable bodywork element of a motor vehicle equipped with at least one cylinder as defined previously. The movable element, without this being limiting, may be selected from openings, such as a sun roof, a tailgate, a bonnet or a gull-wing door, said opening advantageously being made of plastic. Thanks to the invention, when the opening is in closed position, the cylinder is in the position in which its piston head rests against the contact surface and the action of the cylinder on the opening is reduced or even cancelled.

Advantageously, the movable bodywork element can be controlled or assisted by a system with cylinder according to the invention. The movable element may be an airfoil (such as a spoiler, a flap, etc.). In this embodiment, the fact of obtaining a blocking hard point when the cylinder is in open position, in an end of stroke position, is advantageous. In other words, when the piston is out at end of stroke the pressure exerted on the surface of the piston head opposite the rod is such that the cylinder tends to remain open. The cylinder is blocked in this position until sufficient force is applied to the piston to counterbalance the thrust on the piston head opposite the rod.

The invention also relates to a motor vehicle comprising at least one movable element as defined previously.

The invention also relates to the use of a cylinder as defined above as a cylinder of a movable element of a motor vehicle, the opening being in particular made of plastic. Advantageously, the invention relates to the use of the aforementioned cylinder as a cylinder of a tailgate, in particular made of plastic, of a motor vehicle.

The invention will be better understood on reading the accompanying figures, which are given solely by way of example and not limiting in any way, in which:

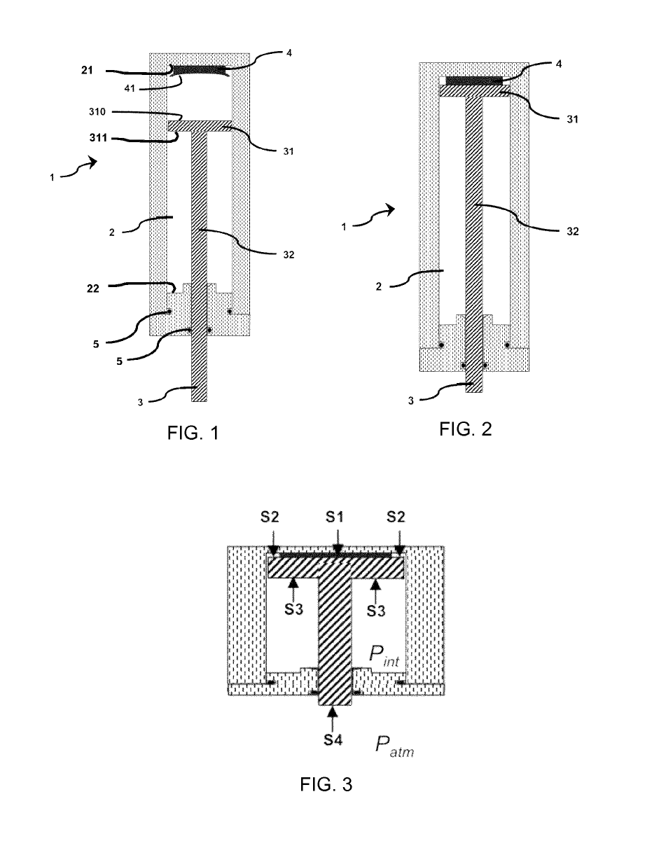

FIG. 1 shows the cylinder in a position in which the piston rod is close to the end of stroke position.

FIG. 2 shows the same cylinder with the piston rod in end of stroke position.

FIG. 3 is a detailed view of the piston head at a distorted scale for the large dimension of the cylinder.

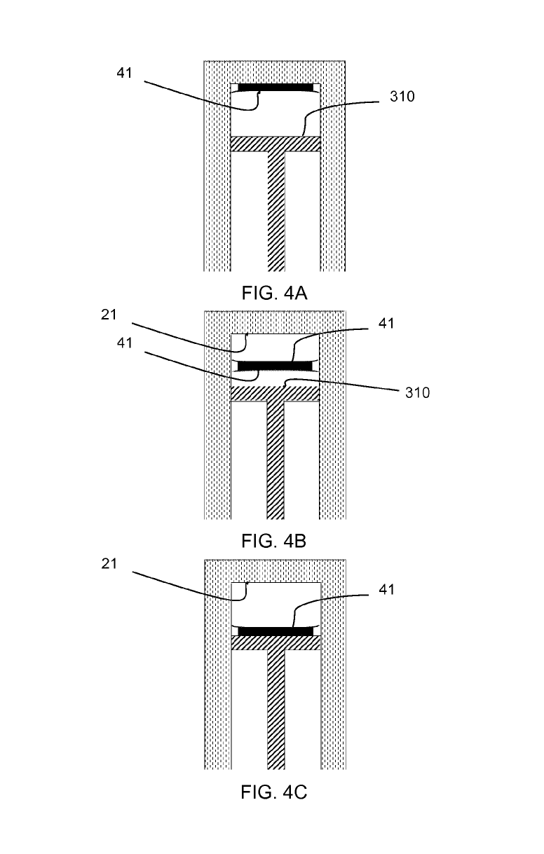

FIGS. 4A to C and 5A to C show the cylinder in a position in which the piston rod is close to the end of stroke position, and where the stop is respectively positioned on the bottom of the chamber (A), between the bottom and the piston head (B) and on the piston head (C).

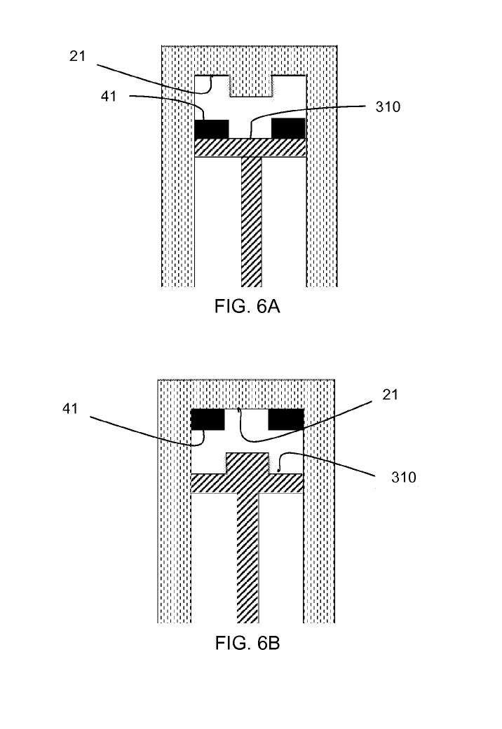

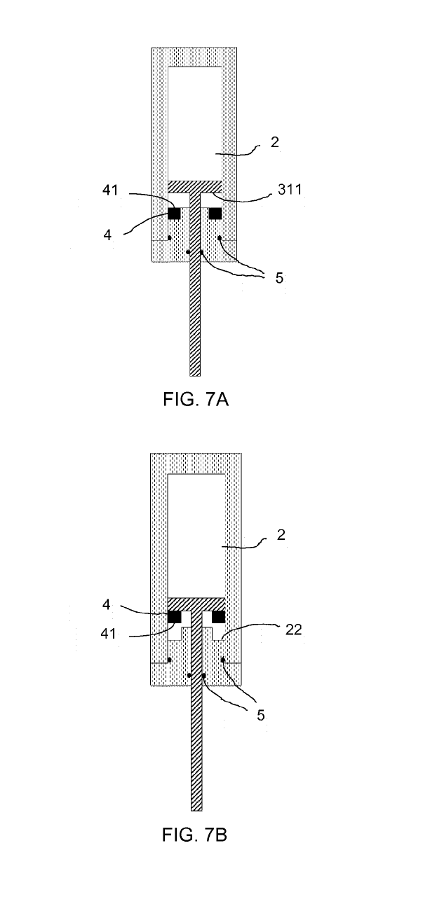

FIGS. 6A, 6B, 7A and 7B show advantageous embodiments of piston and chamber, adapted to cooperate with ring-shaped stops.

We now refer to FIG. 1. The fluid cylinder 1, shown on FIG. 1, comprises a piston 3 and a chamber 2 having two opposite bottoms 21 and 22. In the remainder, only the bottom 21 will be considered. The piston 3 consists of a head 31 and a rod 32. The fluid contained in the chamber 2 is isolated from the outside of the cylinder 1 by seals 5. The seals 5 make the chamber 2 leaktight. In this example, the fluid is air.

When the piston is actuated, the head 31 slides in the chamber 2 between a position where the head is farthest from the bottom 21 of the chamber and a position where the head comes into contact with the bottom 21 of the chamber 2.

The bottom 21 of the chamber 2 has a stop 4 made of a material impermeable to air, such as rubber, elastomer, polyamide, or a convoluted foam material, in particular composite. The stop 4 is fastened to the bottom 21 and therefore cannot be detached.

FIG. 2 shows the cylinder 1 in a position where the piston 3 is fully retracted and is in contact with the stop 4. The piston 3 is at end of stroke.

The stop 4, or at least the contact surface 41 thereof, is impermeable to air, and in particular is impermeable to air and deformable, which has the effect of expelling the air located between the contact surface 41 and the surface 310 of the piston head opposite the rod. The internal pressure which is exerted on the piston head, and which exerts an extraction force, is then reduced or cancelled, or even reversed, depending on the various surfaces involved, as will be explained below.

Advantageously, as shown on FIG. 2, the contact surface 41 and the surface 310 of the piston head opposite the rod are pressed against each other almost perfectly. In other words, while pressed together, the two surfaces (41 and 310) are not separated by the air contained in the chamber.

FIG. 3 shows an enlargement, at a distorted scale, of the bottom of the chamber 2 of the cylinder 1, when the piston 3 is at end of stroke and the contact surface 41 of the stop 4 is in contact with the surface 310 of the piston head 31 opposite the rod 32.

The surface 310 of the head opposite the rod is represented by surfaces S1+S2, where the surface S1 corresponds to the surface of the piston head opposite the rod which comes into contact with the contact surface 41 of the stop 4, and S2 represents the surface of the piston head opposite the rod which does not come into contact with the contact surface 41 of the stop 4.

The surface of the piston head where the rod is positioned either directly or indirectly, which is therefore the surface opposite the surface 310, is represented by the surface S3. The surface S4 corresponds to the surface of the rod itself.

We therefore see that S1+S2=S3+S4.

The internal cylinder pressure, represented by Pᵢₙₜ, is therefore applied on both sides of the piston head (3), namely S1+S2 and S3. Atmospheric pressure (Pₐₜₘ) is applied on the surface of the rod (S4).

The extraction force (F) on the rod is created by the pressure difference applied on these surfaces, and can be represented by the formula: F=Pᵢₙₜ×(S1+S2)−Pᵢₙₜ×S3−Pₐₜₘ×S4.

When the rod is in fully retracted position, and at end of stroke, the piston comes into contact with the deformable stop, which has the effect of reducing the surface on which the internal cylinder pressure is applied. Reduction of this surface reduces, cancels or reverses the rod extraction force.

If the rod is in retracted position, in other words when the surface 41 and the surface 301 are in contact, the pressure exerted on the surface Si is zero. The thrust force formula becomes: F=Pᵢₙₜ×S2−Pᵢₙₜ×S3−Pₐₜₘ×S4.

The force is maximum when the diameter of the contact surface of the stop is equal to the diameter of the piston. In this case, the pressure exerted on the surface S1+S2 is zero and the formula becomes: F=−Pᵢₙₜ×S3−Pₐₜₘ×S4.

The holding force, the stiffness of the elastic stop and the internal pressure will be defined by the sizes of the parts, and will be adapted according to the device to be fitted, and in particular its material.

Ball joints at both ends of the cylinder may be provided to adapt to the geometric dispersions observed when manufacturing parts.

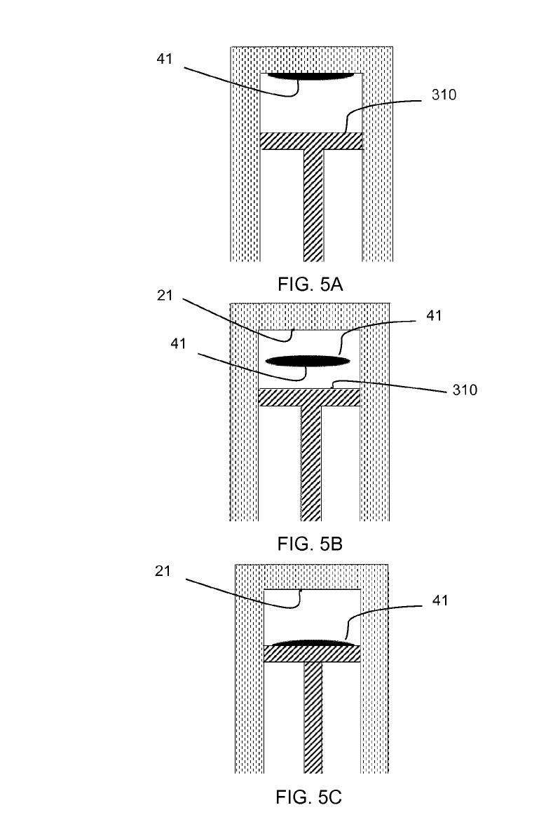

FIGS. 4A to C and 5A to C show advantageous embodiments of the invention. FIGS. 4 illustrate possible positions of a stop 4 having a suction contact surface 41. The stop can be either fixed to the bottom 21 (FIG. 4A), floating (FIG. 4B) or attached to the surface 310 of the piston 3 (FIG. 4C). FIGS. 5 illustrate in the same way various possible positions of an elliptical stop 4.

FIGS. 6A and 6B illustrate special embodiments where the stop is annular. In these embodiments, the bottom of the chamber or the piston head, have a boss cooperating with the recess in the ring-shaped stop.

FIG. 7A shows the cylinder 1 in a position where the piston 3 is almost fully out and almost in contact with the stop 4 positioned on the bottom 22 of the chamber 2.

FIG. 7B shows the cylinder 1 in a position where the piston 3 is almost fully out and almost in contact with the stop 4 positioned on the surface 311 of the piston head in contact with the rod.

The ring-shaped stops 4 are particularly advantageous when the desired effect is to increase the thrust when the rod is out, i.e. when the surface of the piston head in contact with the rod is in contact with the bottom 22 of the chamber.

The invention is not limited to the embodiment described and other embodiments will be clearly apparent to those skilled in the art.

1. A cylinder for a movable bodywork element of a motor vehicle capable of containing a fluid, comprising a chamber and a piston comprising a rod and a piston head, said piston head having a surface opposite said rod and a surface in contact with said rod, said surfaces each being opposite a surface of a bottom of said chamber,
wherein said cylinder comprises at least one stop opposite at least one of said surfaces, said at least one stop having at least one contact surface impermeable to said fluid, said at least one contact surface being opposite a portion of at least one of said surfaces and being arranged to press against said portion of said at least one of said surfaces so as to expel said fluid located between said at least one contact surface and said portion.

2. The cylinder according to claim 1, wherein said surface of bottom of said chamber comprises said at least one stop having said at least one contact surface impermeable to said fluid arranged to press against said portion of said surface of said piston head, so as to expel said fluid located between said surface of said piston head and said at least one contact surface of said at least one stop.

3. The cylinder according to claim 1, wherein said surface of said head comprises said at least one stop having said at least one contact surface impermeable to said fluid arranged to press against said portion of said surface of said bottom of said chamber, so as to expel said fluid located between said surface of said bottom of said chamber and said at least one contact surface of said at least one stop.

4. The cylinder according to claim 1, wherein said at least one contact surface has a hardness less than or equal to 90 Shore A.

5. The cylinder according to claim 1, wherein said at least one contact surface of said at least one stop consists of a layer of rubber, elastomer or polyamide material, or a convoluted foam material.

6. The cylinder according to claim 1, wherein an area of said at least one contact surface is approximately equal to said area of said surface of said piston head opposite said rod.

7. A movable bodywork element of a motor vehicle equipped with said cylinder according to claim 1.

8. The movable element according to claim 7, selected from openings such as a sun roof, a tailgate, a bonnet or a gull-wing door, a spoiler or a flap.

9. A motor vehicle comprising at least one movable element according to claim 7.

10. A part for use on a motor vehicle comprising:
a movable bodywork element; and
a cylinder for said movable bodywork element of said motor vehicle capable of containing a fluid. comprising a chamber and a piston comprising a rod and a piston head, said piston head having a surface opposite said rod and a surface in contact with said rod, said surfaces each being opposite a surface of a bottom of said chamber,
wherein said cylinder comprises at least one stop opposite at least one of said surfaces, said at least one stop having at least one contact surface impermeable to said fluid, said at least one contact surface being opposite a portion of at least one of said surfaces and being arranged to press against said portion of said at least one of said surfaces so as to expel said fluid located between said at least one contact surface and said portion.

11. The cylinder according to claim 2, wherein said at least one contact surface has a hardness less than or equal to 90 Shore A.

12. The cylinder according to claim 3, wherein said at least one contact surface has a hardness less than or equal to 90 Shore A.

13. The cylinder according to claim 2, wherein said at least one contact surface of said at least one stop consists of a layer of rubber, elastomer or polyamide material, or a convoluted foam material.

14. The cylinder according to claim 3, wherein said at least one contact surface of said at least one stop consists of a layer of rubber, elastomer or polyamide material, or a convoluted foam material.

15. The cylinder according to claim 2, wherein an area of said at least one contact surface is approximately equal to said area of said surface of said piston head opposite said rod.

16. The cylinder according to claim 3, wherein an area of said at least one contact surface is approximately equal to said area of said surface of said piston head opposite said rod.

17. A movable bodywork element of a motor vehicle equipped with said cylinder according to claim 2.

18. A movable bodywork element of a motor vehicle equipped with said cylinder according to claim 3.

19. A motor vehicle comprising at least one movable element according to claim 8.
